(19) United States
(12) Patent Application Publication
(10) Pub. No.: US 2011/0317654 A1
(43) Pub. Date: Dec. 29, 2011

(54) WIRELESS TRANSCEIVER, WIRELESS BASE STATION, WIRELESS TERMINAL, AND WIRELESS COMMUNICATION SYSTEM

(75) Inventors: Chie Ishida, Kanagawa (JP); Takahisa Aoyama, Kanagawa (JP); Takashi Tamura, Kanagawa (JP); Jun Hirano, Kanagawa (JP); Daiji Ido, Arlington, VA (US)

(73) Assignee: PANASONIC CORPORATION, Osaka (JP)

(21) Appl. No.: 13/255,369

(22) PCT Filed: Mar. 3, 2010
(86) PCT No.: PCT/JP2010/001457

§ 371 Date: Sep. 8, 2011

(30) Foreign Application Priority Data
Mar. 13, 2009 (JP) 2009-060803

(51) Int. Cl. H04W 72/04

(52) U.S. Cl. 370/329

(57) ABSTRACT

A wireless communication system comprises: a wireless base station that uses dedicated frequencies to communicate with only connected LTE-A terminals and uses shared frequencies to communicate with LTE terminals and LTE-A terminals; and an LTE-A terminal. The wireless base station comprises: a priority information creating section for setting a priority of each of the shared frequencies for idle LTE-A terminals, setting a priority of each of the plurality of frequencies for connected LTE-A terminals, and creating priority information indicative of the set priority; a system information creating section for creating system information that includes the priority information; and a transmission section for transmitting the system information. The LTE-A terminal receives system information transmitted from the wireless base station, and selects a frequency on which the LTE-A terminal camps and a frequency at which the LTE-A terminal transmits an RACH preamble based on the priority information included in the system information. In this way, the LTE-A terminal can be connected to an appropriate carrier.

### RELATED APPLICATION

The present application claims benefit of Japanese Patent Application No. 2009-060803, filed Mar. 13, 2009, the contents of which are hereby incorporated by reference.

### TECHNICAL FIELD

The present invention relates to a technical field of wireless communication, and more specifically, to an LTE-Advanced (Long Term Evolution Advanced) enabled wireless communication system.

### BACKGROUND ART

The LTE-Advanced system is a next generation mobile communication system evolved from LTE (Long Term Evolution), and its object is to provide a more improved mobile communication service.

FIG. 22 is a diagram for illustrating an expected operation at the launch of an LTE-Advanced service. At the launch of the service, it is expected that a carrier dedicated to LTE-Advanced (hereinafter referred to as “dedicated carrier”) and a carrier shared by both LTE and LTE-Advanced (hereinafter referred to as “mixed carrier”) will be used to operate the service in consideration of compatibility between LTE-Advanced and LTE. The term carrier refers to a frequency carrying a signal.

Both an LTE terminal and an LTE-Advanced terminal (hereinafter referred to as “LTE-A terminal”) can access the mixed carrier. Only a connected LTE-Advanced terminal can access the dedicated carrier. An idle LTE-A terminal cannot camp on the dedicated carrier, because system information needs to be transmitted on the dedicated carrier once an idle LTE-A terminal is allowed to camp on the dedicated carrier. Meanwhile, a connected LTE-A terminal can access the mixed carrier.

### CITATION LIST

### Patent Literature

Patent Literature 1: National Publication of International Patent Application No. 2008-523711 Non-Patent Literature
Non-Patent Literature 1: 3GPP TS36.331 v8.4.0 “Evolved Universal Terrestrial Radio Access (E-UTRA) Radio Resource Control (RRC)”

### SUMMARY OF INVENTION

### Technical Problem

On the mixed carrier, system information for LTE-A terminals is transmitted. The system information includes frequency priority information (hereinafter referred to as “priority information”) indicative of a priority for the carrier. For the above reason, the priority is defined such that LTE-A terminals should camp on the mixed carrier. Since performing carrier selection according to the priority information indicated in the system information causes LTE-A terminals to preferentially connect to the mixed carrier, the mixed carrier would become crowded.

In order to solve the problem, when an LTE-A terminal is attempting to access the base station of the mixed carrier, it is necessary to consider the amount of the congestion of the mixed carrier and that of the dedicated carrier, and to handover the LTE-A terminal to the dedicated carrier if the dedicated carrier is available. In order to connect to the dedicated carrier, the LTE-A terminal needs to connect to the mixed carrier and perform a handover to the dedicated carrier.

The present invention has been made in view of such circumstances, and it is an object of the invention to provide a wireless base station, wireless terminal, and wireless communication system, with which an LTE-A terminal can connect to a suitable carrier.

### Solution to Problem

A wireless communication system according to the present invention comprises: a wireless base station that uses dedicated frequencies among a plurality of frequencies to communicate with only connected LTE-Advanced terminals and uses remaining shared frequencies to communicate with LTE terminals and LTE-Advanced terminals; and an LTE-Advanced terminal. The wireless base station comprises: a priority information creating section for setting a priority of each of the shared frequencies for idle LTE-Advanced terminals, setting a priority of each of the plurality of frequencies for connected LTE-Advanced terminals, and creating priority information indicative of the set priority; a system information creating section for creating system information that includes the priority information; and a transmission section for transmitting the system information. The LTE-Advanced terminal comprises: a reception section for receiving system information; a priority determining section for determining a priority for idle state and a priority for connected state, the priority being extracted from the system information and the priority being with respect to frequency; a camp frequency selecting section for selecting a frequency on which the LTE-Advanced terminal camps based on the priority for idle state; a transmit frequency selecting section for selecting a target frequency for an RACH preamble based on the priority for connected state; and an RACH preamble transmitting section for transmitting the RACH preamble at a frequency selected by the transmit frequency selecting section.

### Advantageous Effects of Invention

According to the present invention, since the priority information includes information on a priority of frequency for each of a connected state and an idle state, the priority for idle state may be used to force an LTE-Advanced terminal to camp on a shared frequency and the priority for connected state may be used to force the LTE-Advanced terminal to camp on a dedicated frequency.

As described herein, there are other embodiments of the invention. Therefore, the disclosure of the invention is intended to provide a part of the invention and is not intended to limit the scope of the invention as described and claimed herein.

### BRIEF DESCRIPTION OF DRAWINGS

FIG. 1 is a diagram showing signaling operation of a terminal and a base station according to a first embodiment.

FIG. 2 is a diagram showing a configuration of the base station according to the first embodiment.

FIG. 3 is a diagram showing a configuration of the LTE-A terminal according to the first embodiment.

FIG. 4 is a flow chart for showing operation of the LTE-A terminal according to the first embodiment.

FIG. 5 shows an example of a table of priority information for the LTE-A terminal according to the second embodiment.

FIG. 6 is a diagram showing signaling operation of a terminal and a base station according to a second embodiment.

FIG. 7 is a diagram showing a configuration of the base station according to the second embodiment.

FIG. 8 is a diagram showing a configuration of the LTE-A terminal according to the second embodiment.

FIG. 9 is a flow chart for showing operation of the LTE-A terminal according to the second embodiment.

FIG. 10 shows a variation of the table for indicating priority information.

FIG. 11 shows a variation of the table for indicating priority information.

FIG. 12 shows a variation of the table for indicating priority information.

FIG. 13 shows a variation of the table for indicating priority information.

FIG. 14 shows a variation of the table for indicating priority information.

FIG. 15 shows a variation of the table for indicating priority information.

FIG. 16 is a diagram showing signaling operation of a terminal and a base station according to a third embodiment.

FIG. 17 is a diagram showing a configuration of the base station according to the third embodiment.

FIG. 18 is a diagram showing a configuration of the LTE-A terminal according to the third embodiment.

FIG. 19 is a flow chart for showing operation of the LTE-A terminal according to the third embodiment.

FIG. 20 is a diagram showing a configuration of an LTE-A terminal according to a fourth embodiment.

FIG. 21 is a flow chart for showing operation of the LTE-A terminal according to the fourth embodiment.

FIG. 22 is a diagram for illustrating a possible operation at the launch of an LTE-Advanced service.

### DESCRIPTION OF EMBODIMENTS

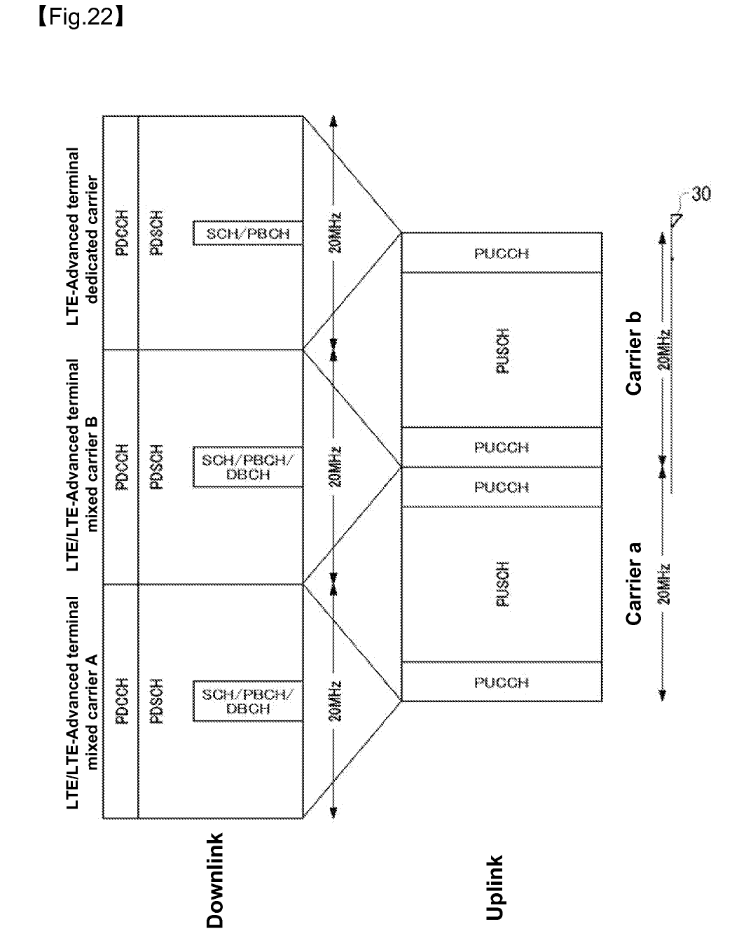

Embodiments of the present invention will now be described in detail below with reference to drawings. In the embodiments, like reference numerals are given to arrangements having like functionality, and duplicate description will be omitted. Embodiments described herein are exemplary only and various modifications can be made to the present invention. Therefore, a specific configuration and functionality disclosed herein do not limit the scope of the claims. In the embodiments below, as a premise, a carrier arrangement of the mixed carrier and the dedicated carrier as shown in FIG. 22 is used.

### First Embodiment

In a first embodiment, priority information for an LTE-A terminal 40 in an idle state (hereinafter referred to as “idle terminal”) and priority information for an LTE-A terminal 40 in a connected state (hereinafter referred to as “connected terminal”) are separately set and included in system information. Only a connection procedure can thereby be used to connect the LTE-A terminal 40 to a dedicated carrier.

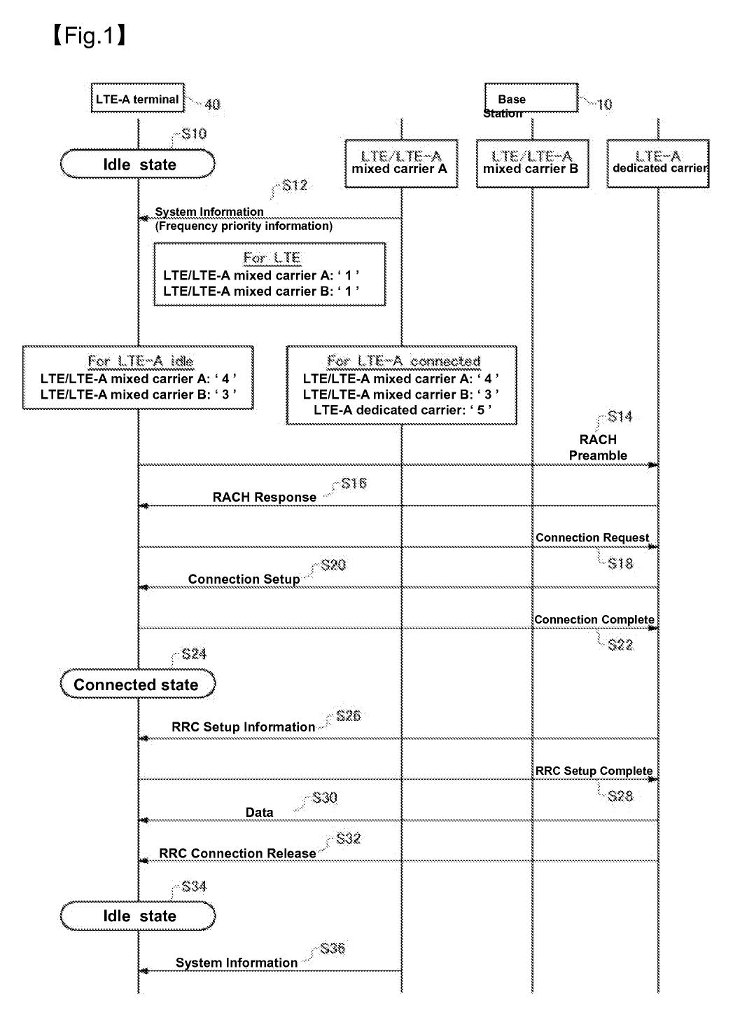

FIG. 1 is a diagram showing signaling operation of a base station 10 and an LTE-A terminal 40 according to a first embodiment. In the example shown in FIG. 1, while in an idle state, the LTE-A terminal 40 is camping on a mixed carrier A (S10). The LTE-A terminal 40 acquires priority information for an idle terminal and priority information for a connected terminal from system information transmitted from the base station 10 (S12). The priority information is represented by numerals of 0 to 7 that can be represented by 3 bits, and a larger number indicates a higher priority. The priority information may also be common on a tracking area basis.

When the LTE-A terminal 40 transmits an RACH preamble, the LTE-A terminal 40 selects an uplink carrier paired with a carrier that has the highest priority indicated in the priority information as an RACH preamble target carrier. The LTE-A terminal 40 uses RACH related parameters for the selected carrier to create an RACH preamble message, and transmits the message to the base station 10 (S14). In FIG. 1, the dedicated carrier has the highest priority. The LTE-A terminal 40 therefore selects an uplink carrier paired with the dedicated carrier and transmits an RACH preamble.

The base station 10 processes the received RACH preamble and returns an RACH response (S16). Once the RACH procedure has been successful, the LTE-A terminal 40 transmits a connection request to the base station 10 (S18), and the base station 10 accordingly transmits a connection setup to the LTE-A terminal 40 (S20). The LTE-A terminal 40 transmits Connection Complete in response to the connection setup (S22), and the LTE-A terminal 40 then establishes connection with the base station 10 on the dedicated carrier and is brought into a connected state (S24).

Subsequently, the base station 10 transmits RRC setup information to the LTE-A terminal 40 (S26), and the LTE-A terminal 40, which has received the RRC setup information, transmits RRC Setup Complete to the base station 10 (S28). The LTE-A terminal 40 and the base station 10 then transmit and receive data to and from each other (S30). Once the base station 10 transmits an RRC Connection Release message to the LTE-A terminal 40 (S32), the LTE-A terminal 40 disconnects from the base station 10 and returns from the connected state to an idle state (S34). If the RRC Connection Release message includes priority information specific to the LTE-A terminal 40, the LTE-A terminal 40 overwrites the priority information acquired from the system information while in an idle state. In the example shown in FIG. 1, the LTE-A terminal 40 follows the priority information indicated by the system information because no specific priority information is indicated.

According to the priority information indicated by the system information or the RRC Connection Release message from the base station 10, the LTE-A terminal 40 selects a frequency that has a higher priority and camps on the frequency. In the example shown in FIG. 1, since the system information indicates the mixed carrier A as a high priority carrier, the LTE-A terminal 40 selects a mixed carrier A and camps on the carrier. The LTE-A terminal 40 receives system information through the mixed carrier A (S36).

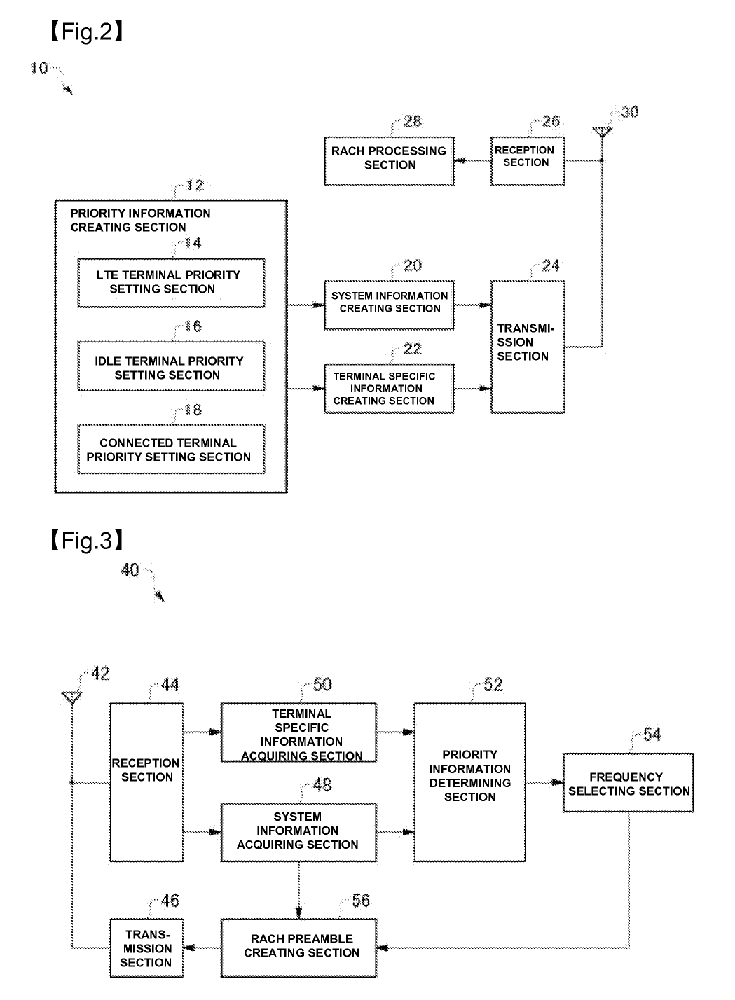

FIG. 2 is a diagram showing a configuration of the base station 10 according to the first embodiment of the invention. The base station 10 comprises a priority information creating section 12, a system information creating section 20, a terminal specific information creating section 22, a transmission section 24, a reception section 26, and an RACH processing section 28.

The priority information creating section 12 comprises an LTE terminal priority setting section 14 for setting a priority for an LTE terminal, an idle terminal priority setting section 16 for setting a priority for an idle terminal, and a connected terminal priority setting section 18 for setting a priority for a connected terminal, and outputs priority information indicative of a priority for each terminal to the system information creating section 20 and the terminal specific information creating section 22.

The system information creating section 20 creates system information that includes priority information for each terminal received from the priority information creating section 12, and transmits it to the transmission section 24. The terminal specific information creating section 22 creates terminal specific information that includes priority information for each terminal received from the priority information creating section 12, and transmits it to the transmission section 24.

The transmission section 24 transmits system information received from the system information creating section 20 and terminal specific information received from the terminal specific information creating section 22 from an antenna 30. The reception section 26 receives an RACH preamble message from the LTE-A terminal 40. The RACH processing section 28 processes the RACH preamble message received from the reception section 26.

FIG. 3 is a diagram showing a configuration of the LTE-A terminal 40 according to the first embodiment. The LTE-A terminal 40 comprises a reception section 44, a transmission section 46, a system information acquiring section 48, a terminal specific information acquiring section 50, a priority information determining section 52, a frequency selecting section 54, and an RACH preamble creating section 56.

The reception section 44 receives system information and terminal specific information transmitted from the base station 10. The system information acquiring section 48 extracts priority information and RACH related information from the system information received from the reception section 44, and outputs them to the priority information determining section 52 and the RACH preamble creating section 56, respectively. The terminal specific information acquiring section 50 extracts priority information from the terminal specific information received from the reception section 44, and outputs it to the priority information determining section 52.

The priority information determining section 52 determines idle terminal priority information and connected terminal priority information received from the system information acquiring section 48 and the terminal specific information acquiring section 50, and outputs a determination result to the frequency selecting section 54.

According to the determination result received from the priority information determining section 52, the frequency selecting section 54 selects a frequency on which the LTE-A terminal 40 camps in an idle state. The frequency selecting section 54 selects a target frequency for an RACH preamble in a connected state, and outputs information on the selected frequency to the RACH preamble creating section 56.

According to the information on the target frequency for an RACH preamble, the RACH preamble creating section 56 selects RACH preamble parameters to be used from the RACH related information. At this time, the information on the target frequency for an RACH preamble is received from the frequency selecting section 54, and the RACH related information is received from the system information acquiring section 48. The RACH preamble creating section 56 uses the RACH preamble parameters to create an RACH preamble message, and outputs the message to the transmission section 46. The transmission section 46 transmits the RACH preamble message received from the RACH preamble creating section 56 from an antenna 42.

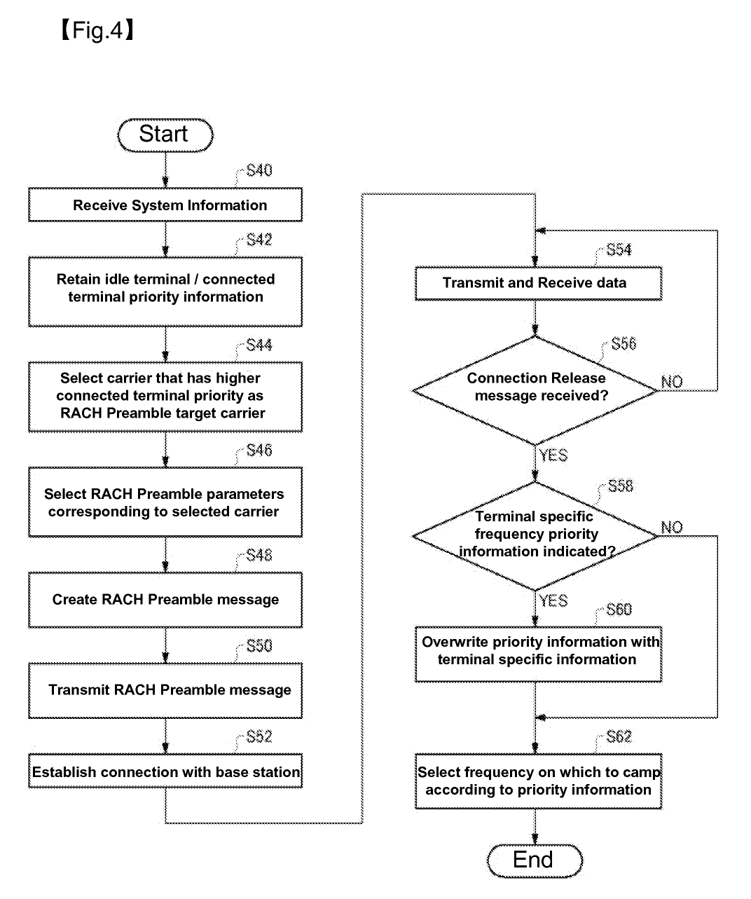

FIG. 4 is a flow chart for showing operation of the LTE-A terminal 40 according to the first embodiment. The LTE-A terminal 40 receives system information from the base station 10 (S40), and retains idle terminal priority information and connected terminal priority information (S42).

When the LTE-A terminal 40 transmits an RACH preamble, the LTE-A terminal 40 selects a carrier that has a higher priority in the connected terminal priority information as an RACH preamble target carrier (S44). The LTE-A terminal 40 selects RACH preamble parameters corresponding to the selected carrier from RACH related parameters acquired from the system information (S46), and creates an RACH preamble message (S48). The LTE-A terminal 40 transmits the created RACH preamble message to the RACH preamble target carrier selected according to the priority information (S50). Once connection is established with the base station 10 (S52), the LTE-A terminal transmits and receives data (S54).

When the LTE-A terminal 40 receives a connection release message from the base station 10 (YES in S56), the LTE-A terminal 40 determines whether terminal specific priority information is indicated in the message (S58). If terminal specific priority information is indicated in the message (YES in S58), the LTE-A terminal 40 overwrites the retained priority information with the indicated priority information (S60). When the LTE-A terminal 40 transitions from a connected state to an idle state, the LTE-A terminal 40 selects a frequency on which the LTE-A terminal 40 camps according to the priority information (S62). The wireless communication system according to the first embodiment has been described above.

In the first embodiment, idle terminal priority information and connected terminal priority information are separately set. The LTE-A terminal 40 can thereby be camped on a mixed carrier in an idle state, while the LTE-A terminal 40 can select a dedicated carrier when the LTE-A terminal 40 transmits an RACH preamble, and can be connected to the dedicated carrier.

As shown in FIG. 1, an idle terminal priority of mixed carrier A may be higher than that of mixed carrier B to collect idle LTE-A terminals 40 into the mixed carrier A. In this way, system information and paging for LTE-A terminals 40 can be transmitted only on the mixed carrier A, and signaling overhead can be reduced for the entire mixed carriers.

Although the example includes different frequency priorities for LTE terminals, idle terminals, and connected terminals in the embodiment described above, the same frequency priority may be used. In this case, the LTE-A terminal 40 selects a carrier that has better reception quality.

Although description has been made in the embodiment described above to the case where priority information is given to a plurality of frequency bands (mixed carriers A and B, and a dedicated carrier) owned by one base station 10, the priority information may be given to a plurality of frequencies owned by another base station. In this case, carriers managed by the same base station 10 may be provided with, for example, the same PCI (Physical Cell Identity). This enables the LTE-A terminal 40 to recognize the base station 10 that owns the carriers. Alternative to providing a PCI, a flag may be provided to other carriers managed by the base station 10 of the carrier on which the LTE-A terminal 40 camps. In this way, it is possible to indicate that the carrier is managed by the same base station 10 as the base station 10 of the carrier on which the LTE-A terminal 40 camps.

### Second Embodiment

In a second embodiment, a base station and an LTE-A terminal have a common table that records a combination of idle terminal priority information and connected terminal priority information. The base station uses a reference number defined in the common table to specify the idle terminal priority information and the connected terminal priority information. The amount of priority information for the LTE-A terminal can thereby be reduced.

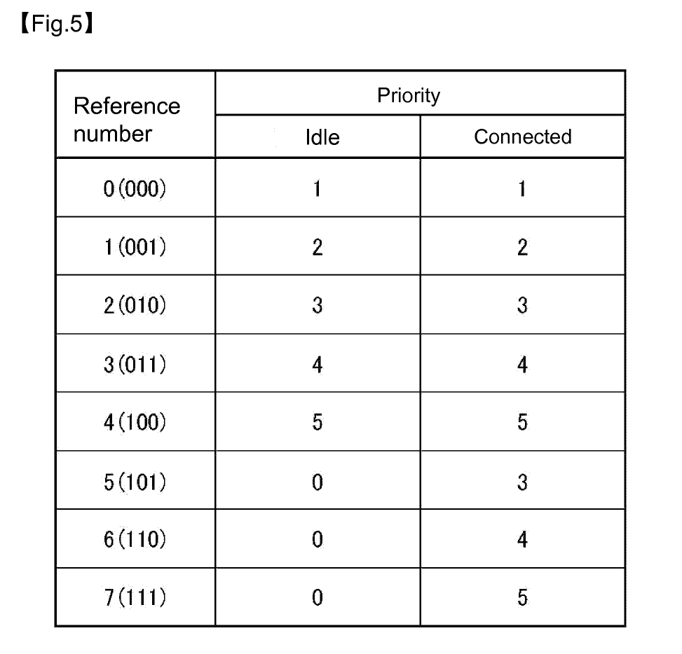

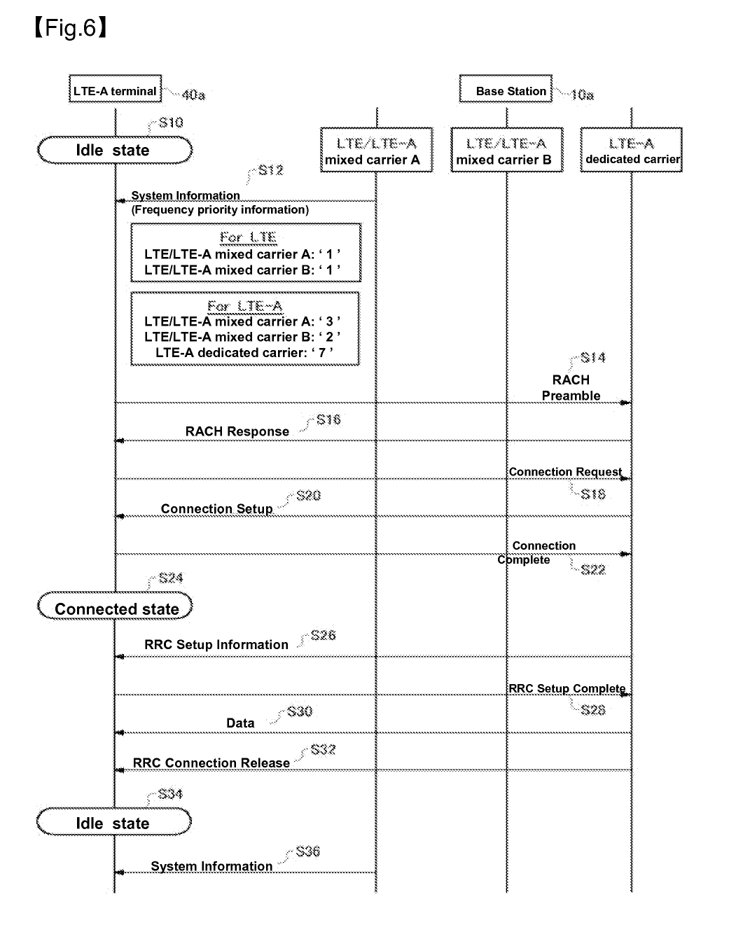

FIG. 5 shows an example of a table of priority information for the LTE-A terminal according to the second embodiment. The table records a combination of an idle terminal priority and a connected terminal priority. It is possible to determine an idle terminal priority and a connected terminal priority by reading a priority corresponding to a reference number from the table. The table may be set at the time of production or sale, or may be transmitted as system information.

In FIG. 5, priorities for idle state and connected state are the same for reference numbers 0 to 4, and idle terminal priorities are zero for reference numbers 5 to 7. Idle terminals do not select carriers identified by any of reference numbers 5 to 7 to camp. In FIG. 5, for example, a carrier identified by a reference number 5 deserves a priority “3” for a connected terminal, while it deserves a priority “0” for an idle terminal.

FIG. 6 is a diagram showing signaling operation of a base station 10a and an LTE-A terminal 40a according to the second embodiment. While in an idle state (S10), the LTE-A terminal 40a is camping on a mixed carrier A. The LTE-A terminal 40a acquires priority information from the base station 10a by means of system information (S12).

When the LTE-A terminal 40a transmits an RACH preamble, the LTE-A terminal 40a selects an uplink carrier paired with a carrier that has the highest priority indicated in the priority information as an RACH preamble target carrier. The LTE-A terminal 40a uses RACH related parameters for the selected carrier to create an RACH preamble message, and transmits the message to the base station 10a (S14).

In the example shown in FIG. 6, the mixed carrier A has a reference number “3” and therefore a priority “4” according to the table (FIG. 5). Similarly, the mixed carrier B has a reference number “2” and therefore a priority “3” and a dedicated carrier has a reference number “7” and therefore a priority “5”. The dedicated carrier has the highest priority. The LTE-A terminal 40a therefore selects an uplink carrier paired with the dedicated carrier and transmits an RACH preamble (S14). Subsequently, the LTE-A terminal 40a performs a connection procedure with the base station 10a, as in the case of the first embodiment (S16 to S22). Once the RACH procedure and the connection setup procedure have been successful, the LTE-A terminal 40a establishes connection with the base station 10a on the dedicated carrier (S24), carries out RRC setup (S26, S28), and transmits and receives data (S30).

The LTE-A terminal 40a receives an RRC Connection Release message from the base station 10a (S32), and returns from the connected state to an idle state (S34). At this time, if the RRC Connection Release message includes terminal specific priority information, the LTE-A terminal 40a overwrites the priority information acquired from the system information while in an idle state.

The LTE-A terminal 40a extracts idle terminal priority information from the priority information indicated by the base station 10a by means of the system information or the RRC Connection Release message, selects a frequency that has a higher priority, and camps on the frequency. In the example shown in FIG. 6, the mixed carrier A has a reference number “3” and therefore a priority “4”, and similarly the mixed carrier B has a reference number “2” and therefore a priority “3”. Since the mixed carrier A has a higher priority, the LTE-A terminal 40a selects a mixed carrier A and camps on the carrier.

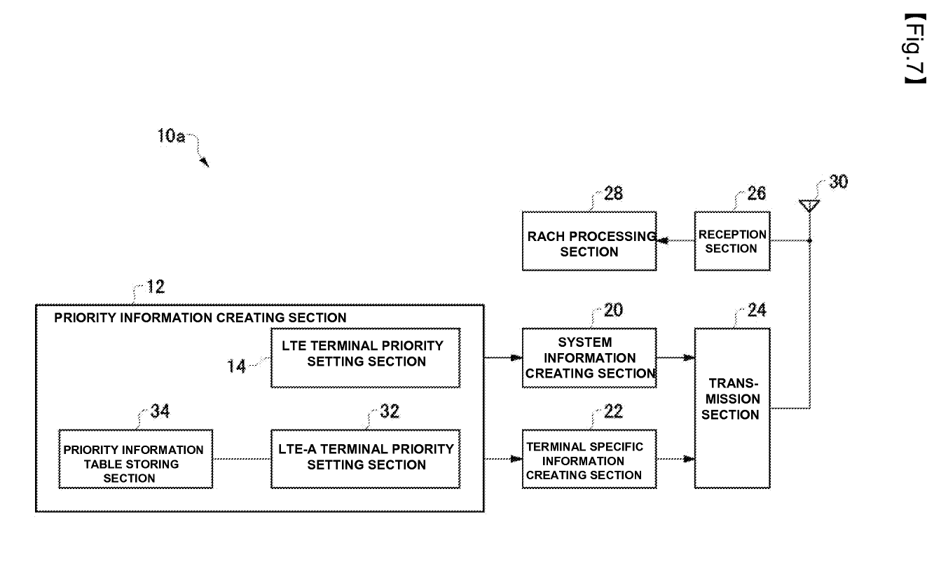

FIG. 7 is a diagram showing a configuration of the base station 10a according to the second embodiment. The base station 10a comprises a priority information creating section 12, a system information creating section 20, a terminal specific information creating section 22, a transmission section 24, a reception section 26, and an RACH processing section 28.

The priority information creating section 12 comprises an LTE terminal priority setting section 14 for providing priority information for LTE terminals, and an LTE-A terminal priority setting section 32. The priority information creating section 12 outputs priority information indicative of a priority for each terminal to the system information creating section 20 and the terminal specific information creating section 22. A priority information table storing section 34 is connected to the LTE-A terminal priority setting section 32. The priority information table storing section 34 has a table as illustrated in FIG. 5 stored thereon. The LTE-A terminal priority setting section 32 reads the table from the priority information table storing section 34, and sets a priority for an LTE-A terminal 40a by selecting a combination of an idle terminal priority and a connected terminal priority stored on the table.

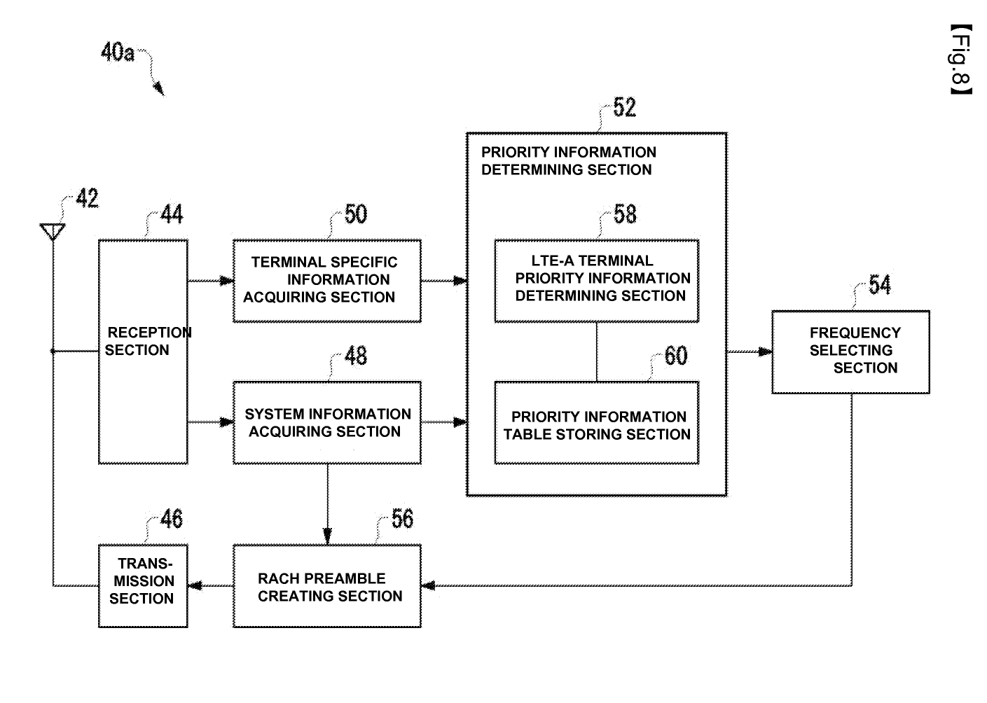

FIG. 8 is a diagram showing a configuration of the LTE-A terminal 40a according to the second embodiment. The LTE-A terminal 40a comprises a reception section 44, a transmission section 46, a terminal specific information acquiring section 50, a system information acquiring section 48, a priority information determining section 52, a frequency selecting section 54, and an RACH preamble creating section 56.

The reception section 44 receives system information and terminal specific information. The system information acquiring section 48 extracts priority information and RACH related information from the system information received from the reception section 44, and outputs them to the priority information determining section 52 and the RACH preamble creating section 56, respectively. The terminal specific information acquiring section 50 extracts priority information from the terminal specific information received from the reception section 44, and outputs it to the priority information determining section 52.

The priority information determining section 52 comprises a LTE-A terminal priority information determining section 58 and a priority information table storing section 60. The priority information table storing section 60 has a table as illustrated in FIG. 5 stored thereon. The LTE-A terminal priority information determining section 58 receives reference numbers indicative of a priority for the LTE-A terminal 40a from the system information acquiring section 48 and the terminal specific information acquiring section 50. The LTE-A terminal priority information determining section 58 reads an idle terminal priority and a connected terminal priority corresponding to the received reference number from the table stored in the priority information table storing section 60. The priority information determining section 52 outputs idle terminal priority information and connected terminal priority information to the frequency selecting section 54.

According to the determination result received from the priority information determining section 52, the frequency selecting section 54 selects a frequency on which the LTE-A terminal 40 camps in an idle state. The frequency selecting section 54 selects an RACH preamble target frequency in a connected state, and outputs information on the selected frequency to the RACH preamble creating section 56.

According to the information on the target frequency for an RACH preamble, the RACH preamble creating section 56 selects RACH preamble parameters to be used from the RACH related information. At this time, the information on the target frequency for an RACH preamble is received from the frequency selecting section 54, and the RACH related information is received from the system information acquiring section 48. The RACH preamble creating section 56 uses the RACH preamble parameters to create an RACH preamble message, and outputs the message to the transmission section 46. The transmission section 46 transmits the RACH preamble message received from the RACH preamble creating section 56 from an antenna 42.

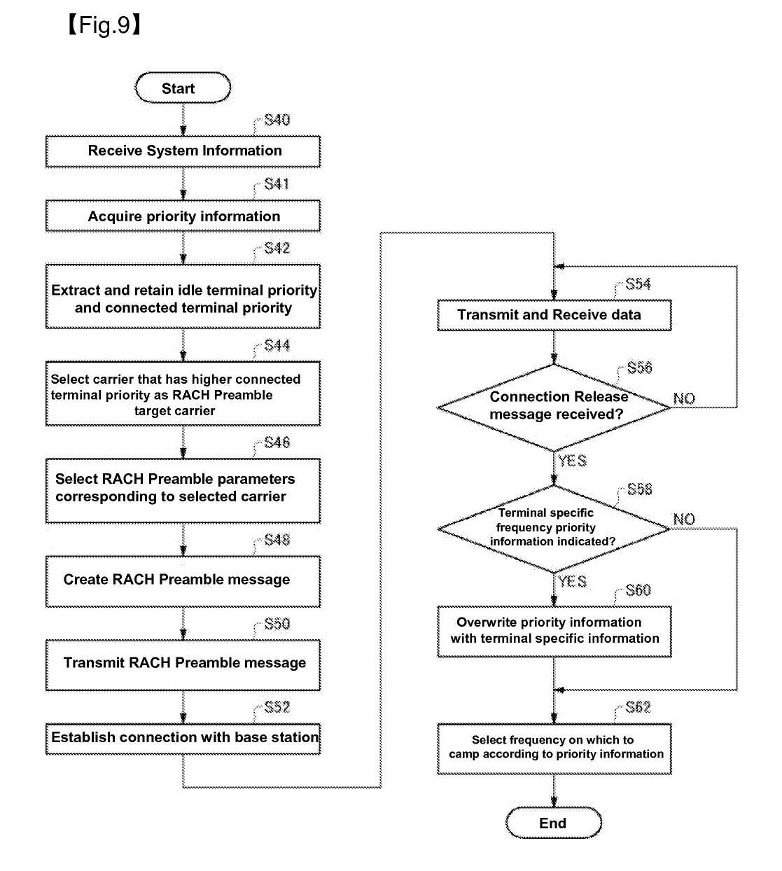

FIG. 9 is a diagram showing operation of the LTE-A terminal 40a according to the second embodiment. The basic operation of the LTE-A terminal 40a according to the second embodiment is similar to that of the LTE-A terminal 40 according to the first embodiment. The LTE-A terminal 40a receives system information from the base station 10a (S40) and acquires priority information (S41). The LTE-A terminal 40a extracts idle terminal priority information and connected terminal priority information from the acquired priority information according to the table 5 as shown in FIG. 5 and retains them (S42). Subsequently, the LTE-A terminal 40a performs frequency selection in a similar way to the LTE-A terminal 40 according to the first embodiment (S44 to S62). The configuration and operation of the wireless communication system according to the second embodiment have been described above.

The wireless communication system according to the second embodiment uses a table of a combination of idle terminal priority information and connected terminal priority information to indicate priority information for each terminal. In this way, it is possible to indicate priority information for both idle and connected terminals with the same number of bits as either idle terminal priority information or connected terminal priority information in the first embodiment, and the amount of priority information for the LTE-A terminal can be reduced. Although description has been made in this embodiment to the case where priority information for both idle and connected terminals is indicated with the same number of bits (3 bits) as idle terminal priority information in the first embodiment, the number of bits may be less.

If it is desired to connect connected terminals to mixed carriers in the embodiment described above, terminal specific priority information may be used to indicate a priority.

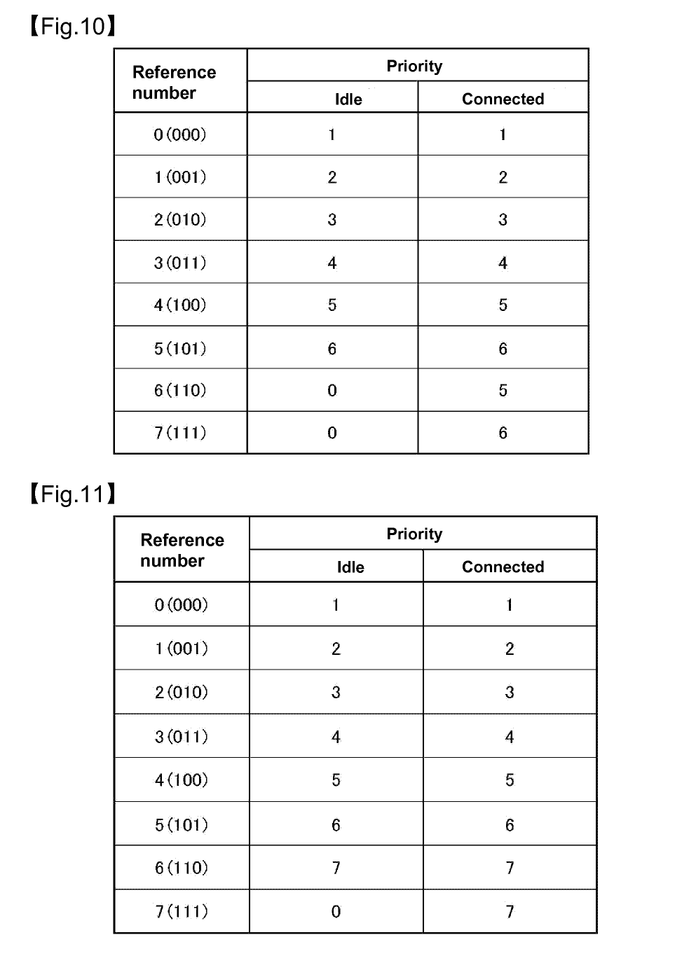

In the embodiment described above, description has been made to an example of table for indicating priority information. However, the table for indicating priority information is not limited to the embodiment described above, and different variations may be conceivable. FIGS. 10 to 15 show variations of the table for indicating priority information.

In a table shown in FIG. 10, priorities for idle state and connected state are the same for reference numbers 0 to 5, and idle terminal priorities are zero for reference numbers 6 to 7. According to the example, priorities for idle state may be set with more freedom than the case in FIG. 5.

In a table shown in FIG. 11, priorities for idle state and connected state are the same for reference numbers 0 to 6, and an idle terminal priority is zero for the reference number 7. According to the example, priorities for idle state may further be set with more freedom than the case in FIG. 10.

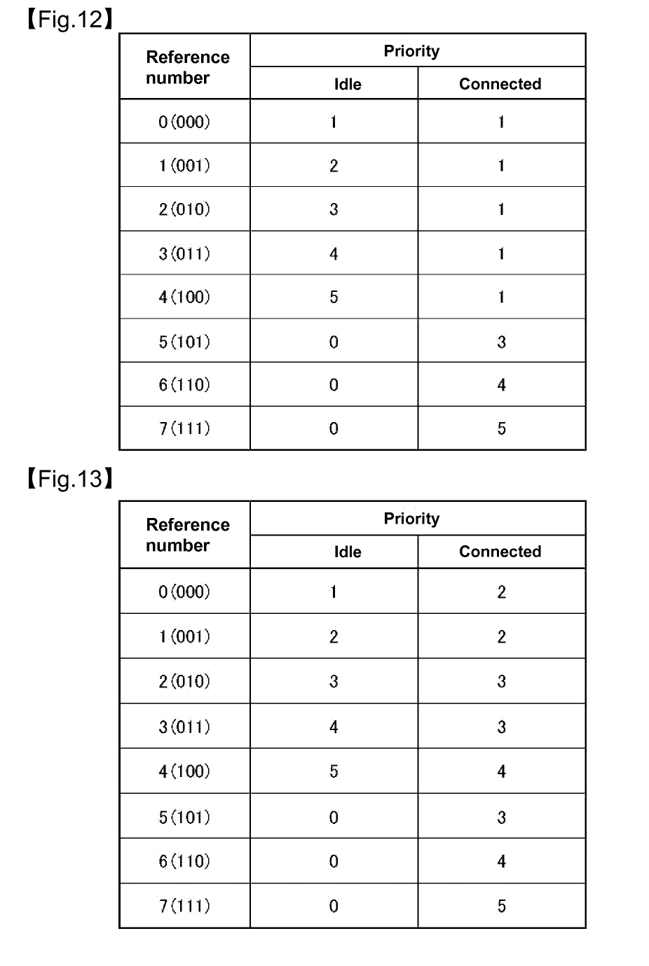

In a table shown in FIG. 12, priorities “1” for connected state are evenly associated with priorities “1” to “5” for idle state for reference numbers 0 to 4. For reference numbers 5 to 7, idle terminal priorities are zero. According to the example, only idle terminal priorities can be varied while connected terminal priorities are kept unchanged. Although connected terminal priorities are all “1” in this example, the connected terminal priority may all be “2”, “3”, or the like. Idle terminal priorities may also be set similarly to the cases in FIGS. 10 and 11 for reference numbers 0 to 5 or 0 to 6, and connected terminal priorities associated therewith may all be the same.

In a table shown in FIG. 13, as a priority for connected state, priorities always lower than the maximum priority for connected state set for a dedicated carrier (in this example, a priority “5” with respect to the reference number 7) are associated with priorities “1” to “5” for idle state for reference numbers 0 to 4. For reference numbers 5 to 7, idle terminal priorities are zero. In this example, for connected terminals, a dedicated carrier has always the highest priority and priorities of mixed carriers can be set with freedom. In this example, priorities “2”, “2”, “3”, “3”, and “4” for connected state are associated with priorities “1” to “5” for idle state. Idle terminal priorities may also be set similarly to the cases in FIGS. 10 and 11 for reference numbers 0 to 5 or 0 to 6, and connected terminal priorities associated therewith may always be lower than the maximum priority of a dedicated carrier.

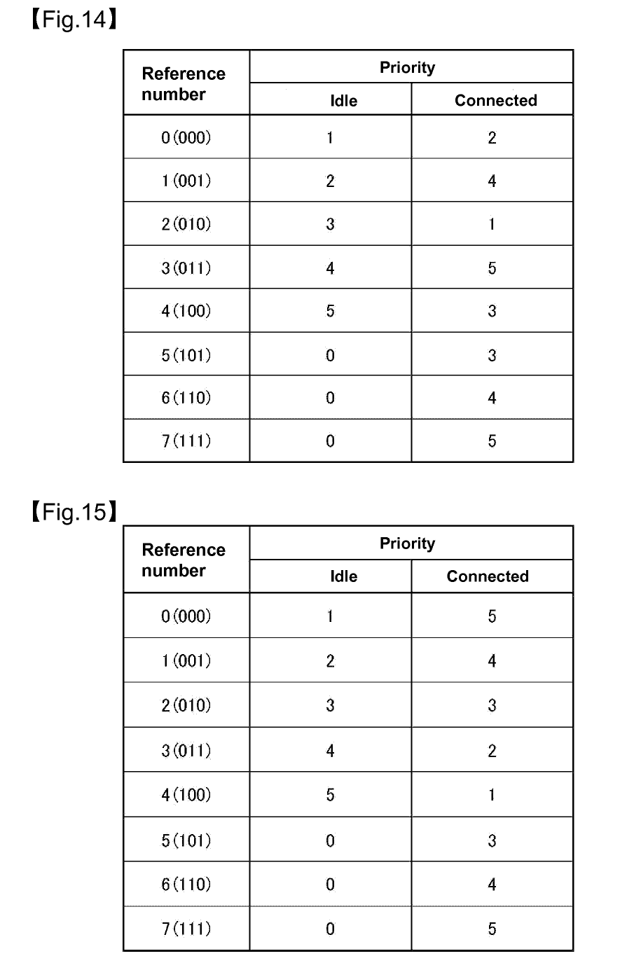

In a table shown in FIG. 14, as a priority for connected state, values arranged in neither ascending nor descending order are associated with priorities “1” to “5” for idle state for reference numbers 0 to 4. Values used to make a combination may be specified as necessary depending on the system operation. For reference numbers 5 to 7, idle terminal priorities are zero. Similarly to the cases in FIGS. 10 and 11, connected terminal priorities may be specified as necessary for reference numbers 0 to 5 or 0 to 6.

In a table shown in FIG. 15, priorities “5” to “1” for connected state are associated with priorities “1” to “5” for idle state for reference numbers 0 to 4. For reference numbers 5 to 7, idle terminal priorities are zero. It is thereby possible to divide carriers that take precedence while a terminal is in an idle state from carriers that take precedence while the terminal is in a connected state. Similarly to the cases in FIGS. 10 and 11, connected terminal priorities may be specified as idle terminal priorities with the order thereof reversed for reference numbers 0 to 5 or 0 to 6.

### Third Embodiment

In a third embodiment, a dedicated carrier priority “0” is set in LTE terminal priority information. Originally, LTE terminals are not allowed to access a dedicated carrier and it is not necessary to set a priority of the dedicated carrier. However, a priority “0” specified in the LTE terminal priority information allows an LTE-A terminal to recognize the dedicated carrier. Specifically, in selecting a frequency on which an LTE-A terminal 40 camps, the LTE-A terminal 40 refers to both LTE terminal priority information and LTE-A terminal priority information. The LTE-A terminal 40 is prevented from camping on a carrier that has a priority “0” in the LTE terminal priority information. Using LTE terminal priority information in this way, an LTE-A terminal 40 can distinguish between frequency priorities in an idle state and a connected state, and the amount of priority information transmitted on a mixed carrier can thereby be reduced.

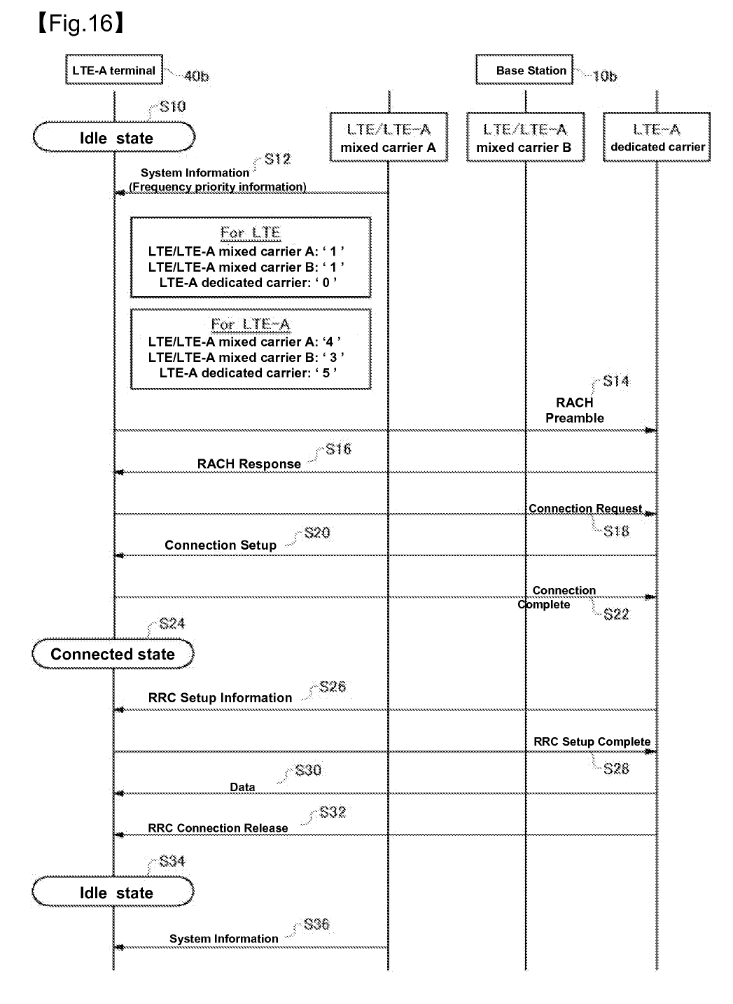

FIG. 16 is a diagram showing signaling operation of a base station 10b and an LTE-A terminal 40b according to the third embodiment. While in an idle state, the LTE-A terminal 40b is camping on a mixed carrier A (S10). The LTE-A terminal 40b acquires LTE terminal priority information and LTE-A terminal priority information from the base station 10 by means of system information (S12).

When the LTE-A terminal 40b transmits an RACH preamble, the LTE-A terminal 40b selects an uplink carrier paired with a carrier that has the highest priority indicated in the priority information as an RACH preamble target carrier, and uses RACH related parameters for the selected carrier to create an RACH preamble message, and transmits the message to the base station 10b (S14).

In the example shown in FIG. 16, the dedicated carrier has the highest priority. The LTE-A terminal 40b therefore selects an uplink carrier paired with the dedicated carrier and transmits an RACH preamble (S14). Subsequently, the LTE-A terminal 40b performs a connection procedure with the base station 10b, as in the case of the first embodiment (S16 to S22). Once the RACH procedure has been successful, the terminal establishes connection with the base station 10b on the dedicated carrier (S24), carries out RRC setup (S26, S28), and transmits and receives data (S30).

The LTE-A terminal 40b receives an RRC Connection Release message from the base station 10b (S32), and returns from the connected state to an idle state (S34). At this time, if the RRC Connection Release message includes terminal specific LTE-A terminal priority information, the LTE-A terminal 40b overwrites the LTE-A terminal priority information acquired from the system information while in an idle state with the new LTE-A terminal priority information.

According to the priority information indicated by the system information or the RRC Connection Release message from the base station 10b, the LTE-A terminal 40b selects a frequency that has a higher priority and camps on the frequency. In the example shown in FIG. 16, although the dedicated carrier is indicated as having a higher priority, a priority is “0” for the dedicated carrier in the LTE terminal priority information. Therefore, the LTE-A terminal 40b ignores the priority of the dedicated carrier in the LTE-A terminal priority information, selects a mixed carrier A and camps on the carrier.

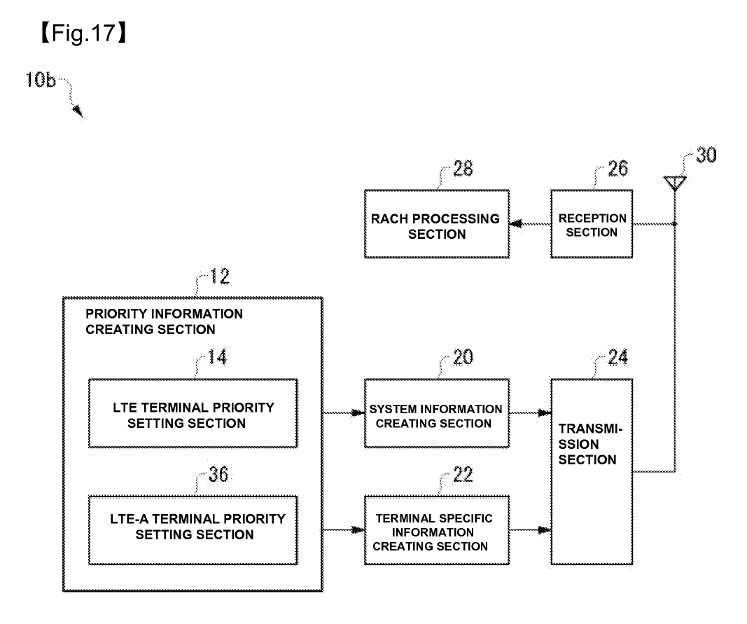

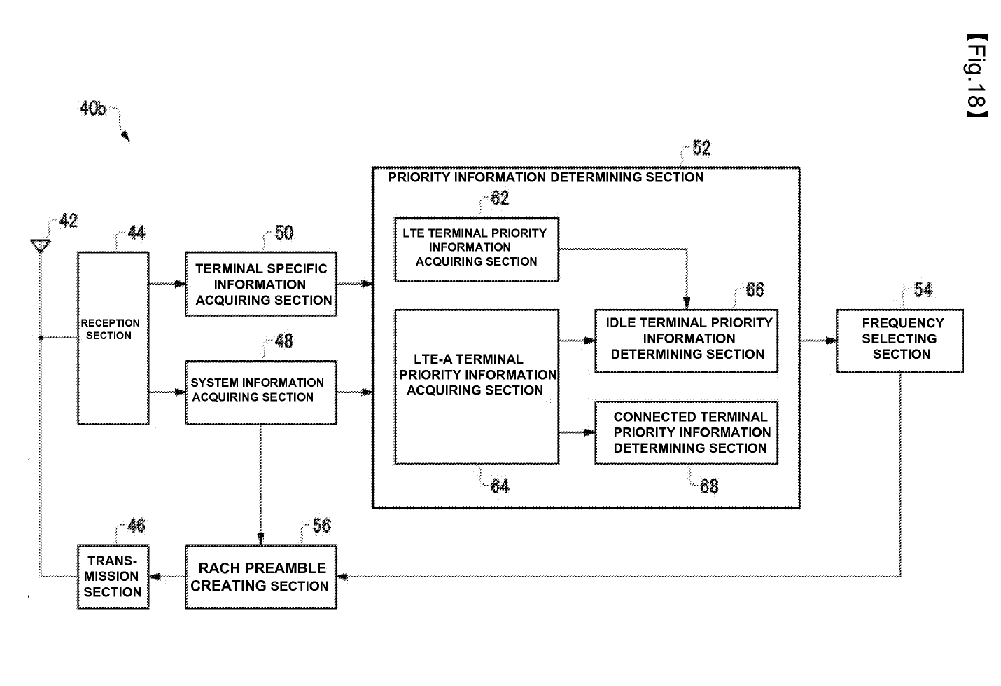

FIG. 17 is a diagram showing a configuration of the base station 10b according to the third embodiment of the invention. The base station 10b comprises a priority information creating section 12, a system information creating section 20, a terminal specific information creating section 22, a transmission section 24, a reception section 26, and an RACH processing section 28.

The priority information creating section 12 comprises an LTE terminal priority setting section 14 for providing priority information for LTE terminals, and an LTE-A terminal priority setting section 36 for providing priority information for LTE-A terminals 40b, and outputs priority information for each terminal to the system information creating section 20 and the terminal specific information creating section 22.

The system information creating section 20 creates system information that includes priority information for each terminal output from the priority information creating section 12, and transmits it to the transmission section 24. The terminal specific information creating section 22 creates terminal specific information that includes priority information for each terminal received from the priority information creating section 12, and transmits it to the transmission section 24. The transmission section 24 transmits system information received from the system information creating section 20 and terminal specific information received from the terminal specific information creating section 22 from an antenna 30.

The reception section 26 receives an RACH preamble message from the LTE-A terminal 40b. The RACH processing section 28 processes the RACH preamble message received from the reception section 26.

FIG. 18 is a diagram showing a configuration of the LTE-A terminal 40b according to the third embodiment. The LTE-A terminal 40b comprises a reception section 44, a transmission section 46, a system information acquiring section 48, a terminal specific information acquiring section 50, a priority information determining section 52, a frequency selecting section 54, and an RACH preamble creating section 56.

The reception section 44 receives system information and terminal specific information. The system information acquiring section 48 extracts priority information and RACH related information from the system information received from the reception section 44, and outputs them to the priority information determining section 52 and the RACH preamble creating section 56, respectively.

The terminal specific information acquiring section 50 extracts priority information from the terminal specific information received from the reception section 44, and outputs it to the priority information determining section 52. The priority information determining section 52 comprises an LTE terminal priority information acquiring section 62, an LTE-A terminal priority information acquiring section 64, an idle terminal priority information determining section 66, and a connected terminal priority information determining section 68.

The LTE terminal priority information acquiring section 62 acquires LTE terminal priority information received from the system information acquiring section 48, and outputs it to the idle terminal priority information determining section 66. The LTE-A terminal priority information acquiring section 64 acquires priority information for LTE-A terminals 40b received from the system information acquiring section 48 and the terminal specific information acquiring section 50, and outputs it to the idle terminal priority information determining section 66 and the connected terminal priority information determining section 68.

The idle terminal priority information determining section 66 receives LTE terminal priority information from the LTE terminal priority information acquiring section 62. The idle terminal priority information determining section 66 removes carriers that have a priority “0” in the LTE-A terminal priority information from the priority information for LTE-A terminals 40b received from the LTE-A terminal priority information acquiring section 64 to determine a frequency priority for an idle terminal, and outputs a determination result to the frequency selecting section 54. The connected terminal priority information determining section 68 receives priority information for LTE-A terminals 40b from the LTE-A terminal priority information acquiring section 64. The connected terminal priority information determining section 68 determines a frequency priority for a connected terminal based on the priority information for LTE-A terminals 40b, and outputs a determination result to the frequency selecting section 54.

According to the determination result received from the priority information determining section 52, the frequency selecting section 54 selects a frequency on which the LTE-A terminal 40 camps in an idle state. The frequency selecting section 54 selects an RACH preamble target frequency in a connected state, and outputs information on the selected frequency to the RACH preamble creating section 56.

According to the information on the target frequency for an RACH preamble, the RACH preamble creating section 56 selects RACH preamble parameters to be used from the RACH related information. At this time, the information on the target frequency for an RACH preamble is received from the frequency selecting section 54, and the RACH related information is received from the system information acquiring section 48. The RACH preamble creating section 56 uses the RACH preamble parameters to create an RACH preamble message, and outputs the message to the transmission section 46. The transmission section 46 transmits the RACH preamble message received from the RACH preamble creating section 56 from an antenna 42.

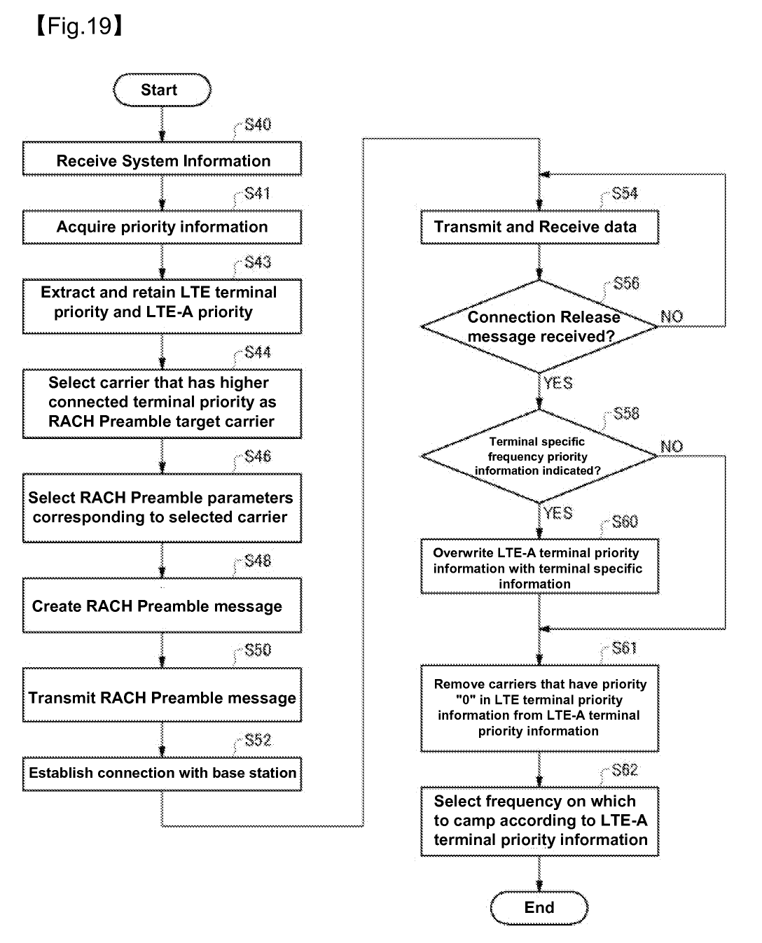

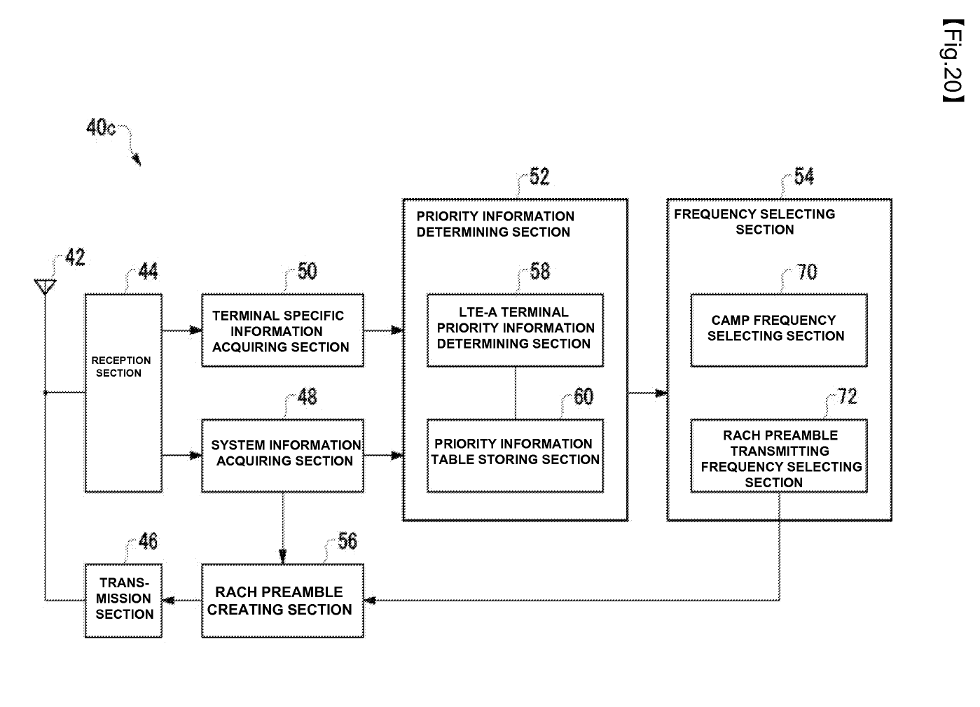

FIG. 19 is a diagram for showing operation of the LTE-A terminal 40b according to the third embodiment. The LTE-A terminal 40b receives system information from the base station 10b (S40) and retains the LTE terminal priority information and the LTE-A terminal priority information (S43).

When the LTE-A terminal 40b transmits an RACH preamble, the LTE-A terminal 40b selects a carrier that has a higher frequency priority in the connected terminal priority information as an RACH preamble target carrier (S44). The LTE-A terminal 40b selects RACH preamble parameters corresponding to the selected carrier from RACH related parameters acquired in the system information (S46), and creates an RACH preamble message (S48). The LTE-A terminal 40b transmits the created RACH preamble message to the RACH preamble target carrier selected according to the priority information (S50). Once connection is established with the base station 10b (S52), the LTE-A terminal 40b transmits and receives data (S54).

When the LTE-A terminal 40b receives a connection release message from the base station 10b (YES in S56), the LTE-A terminal 40b determines whether terminal specific priority information is indicated in the message (S58). If terminal specific priority information is indicated in the message (YES in S58), the LTE-A terminal 40b overwrites the retained LTE-A terminal priority information with the new priority information (S60).

When the LTE-A terminal 40b transitions from a connected state to an idle state, the LTE-A terminal 40b removes carriers that have a priority “0” in the LTE terminal priority information from the LTE-A terminal priority information (S61), and selects a frequency on which the LTE-A terminal 40b camps according to the priority information (S62). The configuration and operation of the wireless communication system according to the third embodiment have been described above.

In the third embodiment, a dedicated carrier priority is indicated as “0” in LTE terminal priority information. In this way, an LTE-A terminal 40b can use LTE terminal priority information to distinguish between frequency priorities in an idle state and a connected state, and the amount of priority information transmitted on a mixed carrier can thereby be reduced.

### Fourth Embodiment

In a fourth embodiment, priority information is used for weighting in selecting RACH transmitting carrier and RACH preamble parameters transmitted in system information. If LTE-A terminals 40 always select a carrier that has a higher priority, the problem is that RACH preamble transmission from the LTE-A terminals 40 concentrates on the particular carrier. Weighting in selecting RACH transmitting carrier can prevent RACH preamble transmission from concentrating on a particular carrier.

A base station used in the fourth embodiment is the same as the base station 10a shown in FIG. 7. Further, signaling operation of an LTE-A terminal 40c according to the fourth embodiment and a base station 10a is the same as that shown in FIG. 6.

FIG. 20 is a diagram showing a configuration of the LTE-A terminal 40c according to the fourth embodiment. The LTE-A terminal 40c comprises a reception section 44, a transmission section 46, a system information acquiring section 48, a terminal specific information acquiring section 50, a priority information determining section 52, a frequency selecting section 54, and an RACH preamble creating section 56.

The reception section 44 receives system information and terminal specific information transmitted from the base station 10a. The system information acquiring section 48 extracts priority information and RACH related information from the system information received from the reception section 44, and outputs them to the priority information determining section 52 and the RACH preamble creating section 56, respectively.

The terminal specific information acquiring section 50 extracts priority information from the terminal specific information received from the reception section 44, and outputs it to the priority information determining section 52. The priority information determining section 52 acquires priority information for LTE-A terminals 40c received from the system information acquiring section 48 and the terminal specific information acquiring section 50. The priority information determining section 52 extracts an idle terminal priority and a connected terminal priority corresponding to the priority information from a table stored in the priority information table storing section 60. The priority information determining section 52 outputs the idle terminal priority and the connected terminal priority to the frequency selecting section 54.

The frequency selecting section 54 comprises a camp frequency selecting section 70 and an RACH preamble transmitting frequency selecting section 72. According to a determination result received from the priority information determining section 52, the camp frequency selecting section 70 selects a frequency on which the LTE-A terminal 40c camps in an idle state. According to a determination result received from the priority information determining section 52, the RACH preamble transmitting frequency selecting section 72 selects a frequency at which the LTE-A terminal 40c transmits an RACH preamble when the LTE-A terminal 40c transitions from an idle state to a connected state. The RACH preamble transmitting frequency selecting section 72 outputs information on the selected RACH preamble target frequency to the RACH preamble creating section 56.

According to the information on the RACH preamble target frequency received from the RACH preamble transmitting frequency selecting section 72, the RACH preamble creating section 56 selects RACH preamble parameters to be used from the RACH related information received from the system information acquiring section 48. At this time, the information on the RACH preamble target frequency is received from the RACH preamble transmitting frequency selecting section 54, and the RACH related information is received from the system information acquiring section 48. The RACH preamble creating section 56 uses the RACH preamble parameters to create an RACH preamble message, and outputs the message to the transmission section 46. The transmission section 46 transmits the RACH preamble message received from the RACH preamble creating section 56 from an antenna 42.

To select a frequency at which the LTE-A terminal 40c transmits an RACH preamble, reception quality of each of carriers may be taken into consideration based on connected terminal priority information. For example, reception quality of a carrier that has a priority “5” may be compared with that of a carrier that has a priority “4”, and if the reception quality of the carrier that has a priority “5” is below a certain predefined value and the reception quality of the carrier that has a priority “4” is above the certain predefined value, the carrier that has a priority “4” may be selected as an RACH preamble target. At this time, the predefined value used to determine the reception quality may be a known value retained by the LTE-A terminal 40c or a value that is broadcast or separately notified to the LTE-A terminal 40c from the base station 10a.

As an alternative way of selecting frequency, it is conceivable to select a carrier that has the highest priority in the first transmission. When the transmission fails, comparison is made between a carrier that has the highest priority and a carrier that has the second highest priority, and determination is then made based on the difference from the comparison whether the RACH preamble should be retransmitted to the carrier that has the highest priority or the RACH preamble should be transmitted to the carrier that has the second highest priority. For example, in the case where a priority of the carrier that has the highest priority is “5” and a priority of the carrier that has the second highest priority is “4” and when RACH preamble transmission to the carrier that has the priority “5” fails, then the RACH preamble is transmitted to the carrier that has the priority “4”. In the case where a priority of the carrier that has the highest priority is “5” and a priority of the carrier that has the second highest priority is “5” and when RACH preamble transmission to the carrier that has the priority “5” fails, then the RACH preamble is retransmitted to the same carrier.

As a further alternative way of selecting frequency, it is conceivable to use a value of frequency priority to calculate the probability of selecting an RACH preamble value assigned to each carrier. For example, consider a frequency A that has a priority “5”, a frequency B that has a priority “4”, and a frequency C that has a priority “2”. The probability of selecting an RACH preamble assigned to each carrier may be calculated as follows: 5/(5+4+2) for the frequency A, 4/(5+4+2) for the frequency B, and 2/(5+4+2) for the frequency C. At this time, if an RACH preamble assigned to the frequency A is selected, the frequency A is designated as a target for the RACH preamble.

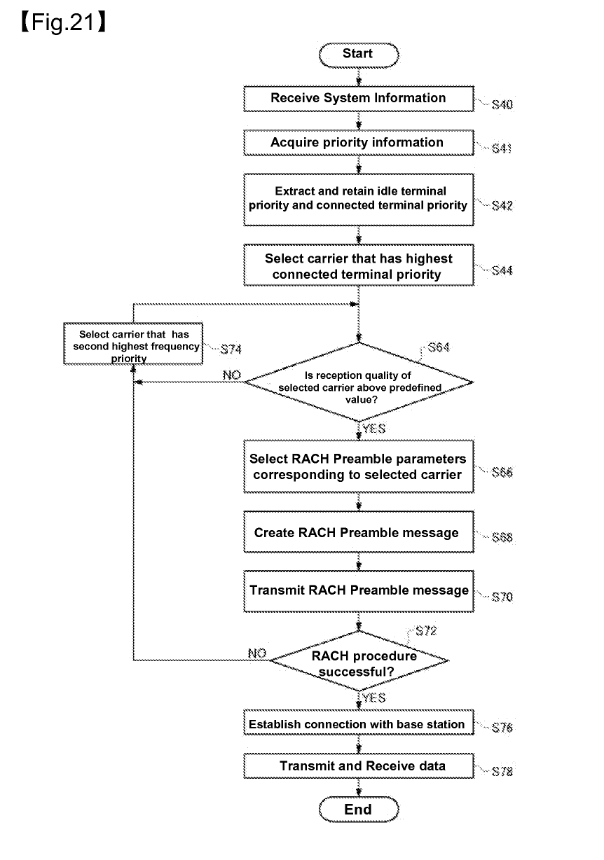

FIG. 21 is a diagram showing operation of the LTE-A terminal 40c according to the fourth embodiment. Here, an RACH preamble target carrier is selected in consideration of reception quality of each of carriers.

The LTE-A terminal 40c receives system information from the base station 10a (S40) and acquires priority information (S41). The LTE-A terminal 40c extracts idle terminal priority information and connected terminal priority information from the acquired priority information according to the table in FIG. 5 and retains them (S42).

When the LTE-A terminal 40c transmits an RACH preamble, the LTE-A terminal 40c selects a carrier that has the highest frequency priority in the connected terminal priority information (S44). If reception quality of the selected carrier is above a predefined value (YES in S64), the LTE-A terminal 40c determines the carrier as the RACH preamble target carrier (S66).

If reception quality of the selected carrier is below a predefined value (NO in S64), the LTE-A terminal 40c selects a carrier that has the second highest frequency priority (S74), and determines reception quality. If the reception quality of the selected carrier is above a predefined value (YES in S64), the LTE-A terminal 40c creates RACH preamble parameters corresponding to the carrier selected as the RACH preamble target. Specifically, the LTE-A terminal 40c selects RACH preamble parameters from RACH related parameters acquired in the system information (S66), and creates an RACH preamble message (S68). The LTE-A terminal 40c transmits the created RACH preamble message to the RACH preamble target carrier selected according to the priority information and the reception quality (S70). At this time, when the RACH procedure has been successful (YES in S72), the LTE-A terminal 40c establishes connection with the base station 10a on the selected carrier (S76), and transmits and receives data (S78).

When the RACH procedure has failed (NO in S72), the LTE-A terminal 40c selects a carrier that has the next highest priority from the connected terminal priority information (S74), determines whether reception quality of the carrier is above a predefined value (S64), and then performs the same process as that described above. Although description has been made here to the case where the LTE-A terminal 40c selects the next carrier when the RACH procedure has once failed, the LTE-A terminal 40c may select the next carrier after the RACH procedure has failed several times. The configuration and operation of the wireless communication system according to the fourth embodiment have been described above.

According to the fourth embodiment, since priority information is used for weighting in selecting RACH transmitting carrier and RACH preamble parameters, it is possible to prevent RACH preamble transmission from concentrating on the particular carrier.

In the embodiment described above, RACH related parameters used to create an RACH preamble message may be common among carriers under control of the base station 10.

Although preferred embodiments of the present invention conceivable at this time have been described, various modifications may be made to the embodiments and the attached claims are intended to encompass all such modifications that fall within the scope and true spirit of the invention.

### INDUSTRIAL APPLICABILITY

According to the present invention, since frequency priorities for each of a connected state and an idle state are provided as priority information, it is possible to force an LTE-Advanced terminal to camp on an appropriate frequency, and the present invention is useful for an LTE-Advanced enabled wireless communication system and the like.

### REFERENCE SIGNS LIST

10 Base station
12 Priority information creating section
14 LTE terminal priority setting section
16 Idle terminal priority setting section
18 Connected terminal priority setting section
20 System information creating section
22 Terminal specific information creating section
24 Transmission section
26 Reception section
28 RACH processing section
30 Antenna
32 LTE-A terminal priority setting section
34 Priority information table storing section
36 LTE-A terminal priority setting section
40 LTE-A terminal
42 Antenna
44 Reception section
46 Transmission section
48 System information acquiring section
50 Terminal specific information acquiring section
52 Priority information determining section
54 Frequency selecting section
56 RACH preamble creating section
58 LTE-A terminal priority information determining section
60 Priority information table storing section
62 LTE terminal priority information acquiring section
64 LTE-A terminal priority information acquiring section
66 Idle terminal priority information determining section
68 Connected terminal priority information determining section
70 Camp frequency selecting section
72 RACH preamble transmitting frequency selecting section

1. A wireless transceiver that uses dedicated frequencies among a plurality of frequencies to communicate with only LTE-Advanced terminals in a connected state and uses remaining shared frequencies to communicate with LTE terminals and LTE-Advanced terminals, the wireless transceiver comprising:
a priority information creating section for setting a priority of each of the plurality of frequencies for connected LTE-Advanced terminals, setting a priority of each of the shared frequencies for idle LTE-Advanced terminals, and creating priority information indicative of the set priority;
a system information creating section for creating system information that includes the priority information; and
a transmission section for transmitting the system information.

2. The wireless transceiver according to claim 1, further comprising
a terminal specific information creating section for creating terminal specific information that includes the priority information,
wherein the transmission section transmits the terminal specific information.

3. The wireless transceiver according to claim 1, further comprising
a table that records combinations of a priority for an idle LTE-Advanced terminal and a priority for a connected LTE-Advanced terminal in association with reference numbers,
wherein the priority information creating section selects a combination of a priority for idle state and a priority for connected state for each of the plurality of frequencies among the combinations recorded in the table and sets a reference number associated with the combination as a priority for the frequency.

4. The wireless transceiver according to claim 1, wherein
the priority information creating section comprises
an LTE-A terminal priority setting section for setting a priority of each of the plurality of frequencies for LTE-Advanced terminals, and
an LTE terminal priority setting section for setting a priority of each of the shared frequencies for LTE-Advanced terminals,
wherein the LTE-A terminal priority setting section sets a priority of each frequency for a connected LTE-A terminal, and
the LTE terminal priority setting section sets a priority indicative of unavailability of the dedicated frequencies.

5. A wireless base station comprising the wireless transceiver according to claim 1.

6. A wireless transceiver capable of communicating at a plurality of frequencies, comprising:
a reception section for receiving system information;
a priority determining section for determining a priority for idle state and a priority for connected state, the priority being extracted from the system information and the priority being with respect to frequency;
a camp frequency selecting section for selecting a frequency on which the wireless transceiver camps based on the priority for idle state;
a transmit frequency selecting section for selecting a target frequency for an RACH preamble based on the priority for connected state; and
an RACH preamble transmitting section for transmitting the RACH preamble at a frequency selected by the transmit frequency selecting section.

7. The wireless transceiver according to claim 6, wherein
the reception section receives terminal specific information transmitted from a base station, and
the priority determining section determines priority information of a frequency extracted from the terminal specific information.

8. The wireless transceiver according to claim 6, further comprising
a table that records a combination of a priority for idle state and a priority for connected state in association with a reference number,
wherein the system information includes the reference number as priority information, and
the priority determining section reads respective priorities for idle state and a priority for connected state corresponding to the reference number from the table.

9. The wireless transceiver according to claim 6, wherein
the system information includes LTE-Advanced terminal priority information and LTE terminal priority information, a priority indicative of unavailability of a dedicated frequencies being set in the LTE terminal priority information,
the priority determining section determines a priority for connected state based on the LTE-Advanced terminal priority information, identifies the dedicated frequencies according to the LTE terminal priority information indicative of unavailability, and excludes the dedicated frequencies according to the LTE-Advanced terminal priority information to determine a priority for idle state.

10. The wireless transceiver according to claim 6, wherein, when the RACH preamble transmitting section has failed to transmit an RACH preamble, the transmit frequency selecting section reselects a target frequency at which the RACH preamble is to be transmitted, based on the priority.

11. A wireless terminal comprising the wireless transceiver according to claim 6.

12. A wireless communication system comprising: a wireless base station that uses dedicated frequencies among a plurality of frequencies to communicate with only LTE-Advanced terminals in a connected state and uses remaining shared frequencies to communicate with LTE terminals and LTE-Advanced terminals; and an LTE-Advanced terminal,
the wireless base station comprising:
a priority information creating section for setting a priority of each of the shared frequencies for idle LTE-Advanced terminals, setting a priority of each of the plurality of frequencies for connected LTE-Advanced terminals, and creating priority information indicative of the set priority;
a system information creating section for creating system information that includes the priority information; and
a transmission section for transmitting the system information, and
the LTE-Advanced terminal comprising:
a reception section for receiving system information;
a priority determining section for determining a priority for idle state and a priority for connected state, the priority being extracted from the system information and the priority being with respect to frequency;
a camp frequency selecting section for selecting a frequency on which the LTE-Advanced terminal camps based on the priority for idle state;
a transmit frequency selecting section for selecting a target frequency for an RACH preamble based on the priority for connected state; and
an RACH preamble transmitting section for transmitting the RACH preamble at a frequency selected by the transmit frequency selecting section.

13. A method for notifying priority by use of wireless transceiver that uses dedicated frequencies among a plurality of frequencies to communicate with only LTE-Advanced terminals in a connected state and uses remaining shared frequencies to communicate with LTE terminals and LTE-Advanced terminals, the method comprising, by the wireless transceiver:
setting a priority of each of the plurality of frequencies for connected LTE-Advanced terminals, setting a priority of each of the shared frequencies for idle LTE-Advanced terminals, and creating priority information indicative of the set priority;
creating system information that includes the priority information; and
transmitting the system information.

14. A method for selecting a frequency by use of an LTE-Advanced terminal capable of communicating at a plurality of frequencies, the method comprising, by the LTE-Advanced terminal:
receiving system information;
determining a priority for idle state and a priority for connected state, the priority being extracted from the system information and the priority being with respect to frequency;
selecting a frequency on which the LTE-Advanced terminal camps based on the priority for idle state;
selecting a target frequency for an RACH preamble based on the priority for connected state; and
transmitting the RACH preamble at the selected frequency.
